(19) United States
(12) Patent Application Publication
(10) Pub. No.: US 2006/0285998 A1
(43) Pub. Date: Dec. 21, 2006

(54) Collapsible funnel

(76) Inventor: Chris Barksdale, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/154,353

(22) Filed: Jun. 16, 2005

(51) Int. Cl. B01L 3/00

(52) U.S. Cl. 422/100

(57) ABSTRACT

A collapsible or foldable funnel having side walls joined by longitudinal folds and one or more flap members that bridge the longitudinal folds, whereby the flap members are inverted from a non-engaged position into an engaged position internal to the funnel in order to apply an outward biasing force against the side walls adjoining the longitudinal folds to maintain the funnel in an expanded configuration.

### BACKGROUND OF THE INVENTION

This invention relates generally to the field of funnels, and more particularly relates to the funnels that are collapsible or folded into a flat configuration for storage and expandable into an expanded configuration for use. Even more particularly, the invention relates to such collapsible or folded funnels that incorporate means to maintain the funnel in the expanded configuration during use.

Funnels that are collapsed or folded into a flat configuration for storage prior to use are known. Examples of funnels or similar devices that are expanded for use from a flat or collapsed configuration are seen in U.S. Pat. No. 2,100,888 to Vine, U.S. Pat. No. 3,767,246 to Corelli et al., U.S. Pat. No. 4,108,222 to Kaufman, U.S. Pat. No. 5,797,636 to Hamynen, U.S. Pat. No. 6,460,200 to Mottale et al., U.S. Pat. No. D299,302 to Gray, U.S. Pat. No. D374,281 to Markles, U.S. Pat. No. D394,989 to Block, U.S. Pat. No. D475,901 to Makino et al., and U.S. Pat. No. D499,482 to Gugliotta. Such devices are constructed of a paper, cardboard or plastic material that maintains a generally planar configuration unless bent or flexed. In the non-use or storage configuration, the devices may comprise a flat single layer of material that is folded and joined into a configuration that can be expanded into a three dimensional configuration, or the non-use configuration may comprise two or more layers in a folded configuration, the edges of the material having been joined by an adhesive or other suitable means. By pressing against opposing longitudinal folds or edges, the devices can be flexed from a flat configuration into an expanded configuration with an open interior to receive a liquid, particulate matter or other objects.

A problem with most of the known designs for collapsible or foldable funnels is that the funnels will not remain in the expanded configuration unless continuous force is applied against the opposing folds or edges. This creates a difficulty in use, in that the operator must keep one hand on the funnel in order to prevent it from returning to the flat configuration.

It is an object of this invention to provide a collapsible or folded funnel having a generally flat configuration during non-use or storage and an expanded or open configuration for use, wherein the expanded configuration is self-maintaining, such that the user does not need to provide continuous flex against the opposing edges or folds of the funnel to maintain it in the expanded configuration. It is a further object to provide such a funnel wherein the means to maintain the funnel in the expanded configuration are provided integral with the funnel design and structure, such that no secondary or external mechanism is required. It is a further object to provide such a funnel wherein the means to maintain the funnel in the expanded configuration comprise one or more flap members disposed at the large, receiving end of the funnel, wherein each of the flap members extends across or bridges a longitudinal fold of the funnel body and is capable of being folded inwardly such that the flap members are inverted and provide an outwardly directed biasing force against the longitudinal fold of the funnel, thereby maintaining the funnel in the expanded configuration.

### SUMMARY OF THE INVENTION

The invention is in general a funnel that is collapsible or foldable into a flattened configuration for storage, packaging or the like, which can be flexed or expanded into a three-dimensional expanded or open configuration for use by pressing against opposing edges of the funnel, the funnel being generally tapered or conical and having a relatively large receiving opening and a relatively small dispensing opening. The funnel is composed of a relatively rigid yet slightly flexible material, such as paper, cardboard, plastic or the like.

Retainer means are provided to maintain the funnel in the expanded or open configuration, such that the user does not need to continue to apply pressure against opposing edges of the funnel to retain the expanded configuration once the retainer means are engaged. The retainer means comprise one or more flap members positioned at the receiving opening, where the flap member extends across or bridges a longitudinal fold line. With the funnel manually expanded, the flap member is folded inward and inverted, thereby applying an outward bias to each side of the fold line that maintains the adjoining side walls in an open configuration. Preferably, plural flap members are provided. The flap members may be configured in various shapes.

### BRIEF DESCRIPTION OF THE DRAWINGS

FIG. 1 is a plan view showing a funnel in the flat, non-expanded configuration.

FIG. 2 is a perspective view showing the funnel of FIG. 1 in the expanded or open configuration, prior to engagement of the flap members

FIG. 3 is a partial perspective view of the funnel of FIGS. 1 and 2 showing three of four flap members inverted into the engagement position to maintain the funnel in the expanded configuration.

FIG. 4 is a partial perspective view similar to FIG. 3 of an alternative embodiment of the invention, wherein the flap members are rectilinear.

FIG. 5 is a partial perspective view similar to FIG. 3 of an alternative embodiment of the invention, wherein the flap members are curved.

FIG. 6 is a plan view of an alternative embodiment of the invention, shown in the flat configuration, wherein the expanded configuration is formed by joining slots and tabs.

FIG. 7 is a partial plan view similar to FIG. 1 showing small flap members disposed at the dispensing end of the funnel.

### DETAILED DESCRIPTION OF THE INVENTION

With reference to the drawings, the invention will now be described in detail with regard for the best mode and the preferred embodiment. In a most general sense, the invention is a collapsible or foldable funnel that can be collapsed or folded during non-use into a generally flat configuration of minimal thickness, but which can be expanded or opened for use by applying pressure against generally opposing longitudinal edges, wherein retainer means are provided to maintain the funnel in the open or expanded configuration. The funnel may be composed of paper, cardboard, plastic or other material with similar properties having suitable stiffness and flexibility.

As shown in FIGS. 1 through 3, a preferred embodiment of the funnel 10 comprises a tapered or conical device having side walls 11, a top edge 12, a bottom edge 13 and longitudinal folds 14. The funnel 10 is depicted as four sided in the illustrations, but it is to be understood that the funnel 10 may have any number of sides such that at least one longitudinal fold 14 is present, such that in the open or expanded configuration the funnel 10 is formed by a plurality of adjoining side walls 11, either planar or curved, that define an open interior. The funnel 10 further comprises a top edge 12 and a bottom edge 13, with the top edge 12 defining a relatively large receiving opening 17 and the bottom edge 13 defining a relatively small dispensing opening 18. Each side wall 11 comprises an interior surface 15 and an exterior surface 16.

The funnel 10 further comprises retainer means 20 to maintain the funnel 10 in the expanded configuration. Retainer means 20 comprise at least one and preferably multiple flap members 21 disposed on and extending outwardly from the top edge 12 of the funnel 10 in the non-engaged status. Each flap member 21 is positioned so as to bridge or extend across a longitudinal fold 14. The flap member 21 comprises a flap longitudinal fold 22 parallel to the longitudinal fold 14, preferably being an extension thereof, an interior surface 23 and an exterior surface 24. The flap member 21 is joined to the side walls 11 by top edge folds 25 which preferably are extensions of and help define the top edge 12. The top edge folds 25 are preferably creased or inscribed to facilitate inversion of the flap members 21. Most preferably, a flap member 21 is provided for each longitudinal fold 14.

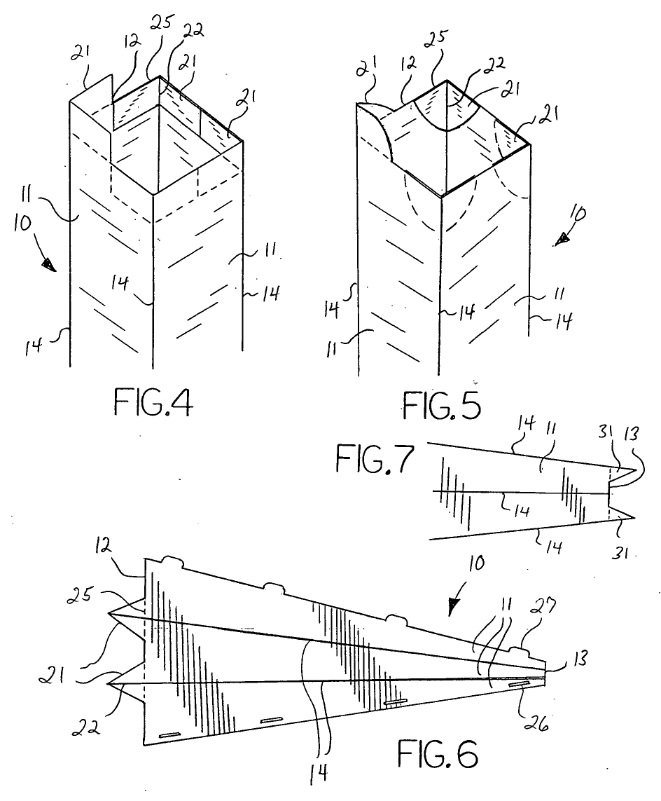

The flap members 21 may be of various configurations, such as for example triangular as shown in FIGS. 1 through 3 and 6, rectilinear as shown in FIG. 4, or curved as shown in FIG. 5.

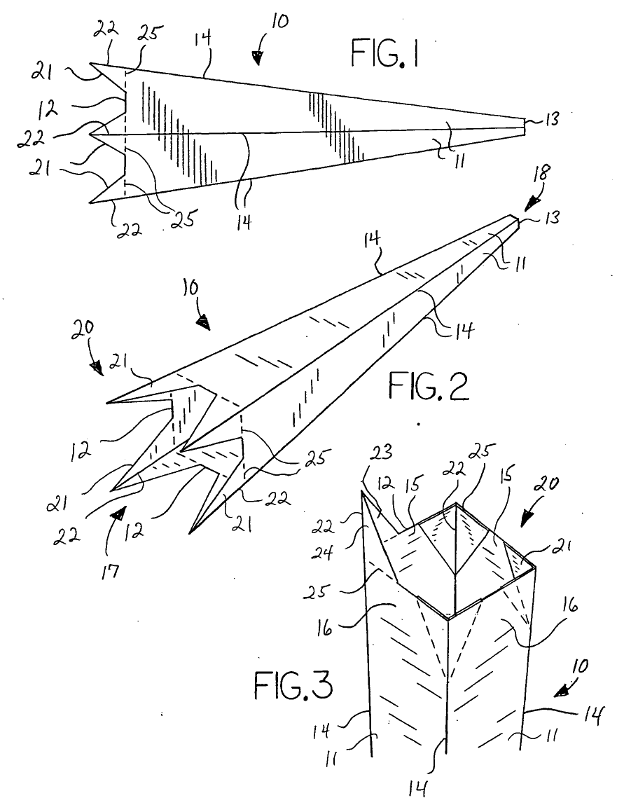

In the non-use or storage configuration as shown in FIG. 1, the funnel 10 is collapsed or folded so as to be flat with minimal thickness, the interior surfaces 15 of the side walls 11 being in contact such that no open interior exists. In this manner, the funnel 10 can be easily stored, or multiple funnels 10 can be provided in a stack that encompasses a relatively small space. To expand the funnel 10 into the expanded or open configuration, the opposing outer longitudinal folds 14 defining longitudinal edges in the flat configuration are manually pressed together, such that the interiorly disposed longitudinal folds 14 and the side walls 11 separate to create an open interior, a relatively large receiving opening 17 and a relatively small dispensing opening 18, as seen in FIG. 2.

In order to maintain the funnel 10 in the expanded configuration without the need to maintain manual pressure against opposing longitudinal folds 14, the flap members 21 are folded inwardly and inverted into an engaged status, as shown in FIGS. 3 through 5. The flap member 21 is pressed inwardly into and through the receiving opening 17 by folding it along the top edge fold 25. As the flap member 21 passes through the plane defined by the receiving opening, it will invert bilaterally along the flap longitudinal fold 22, such that the flap interior surfaces 23 will abut the side wall interior surfaces 15, the flap longitudinal fold will be disposed parallel to the side wall longitudinal fold 14, and the flap exterior surface 24 will be exposed within the funnel 10. The inversion causes the flap member 21 to exert outward pressure or bias against the side walls 11 adjoining the longitudinal fold 14, thereby maintaining the open angle determined by the number of side walls 11 and thus maintaining the funnel 10 in the expanded configuration. For example, in a funnel 10 with four side walls 11 as shown in FIGS. 1 through, the angle will be approximately 90 degrees. For a funnel having three side walls 11, as shown in FIG. 6, the angle will be approximately 120 degrees.

It is preferred that the side walls 11 all be joined, either by manufacturing a seamless funnel 10 or by bonding free edges together, such that the funnel 10 will have two or more layers when disposed in the flat configuration. In an alternative embodiment, as shown in FIG. 4, the funnel 10 may be provided in a single layer configuration such that two of the side walls 11 must be joined to form a three-dimensional funnel 10. This may be accomplished for example by providing an adhesive, moisture activated or covered by a release layer, or by providing mechanical joining members such as the tabs 27 and slots 26 shown in FIG. 6.

In circumstances where stability of the small dispensing opening 18 is critical, one or more small flap members 31 similar in configuration, operation and purpose to flap members 21 may be provided along bottom edge 13, as shown in FIG. 7. Inverting the small flap members 31 reinforces the dispensing opening 18 and maintains it in a broadly open configuration.

It is understood that equivalents and substitutions to certain elements set forth above may be obvious to those skilled in the art, and therefore the true scope and definition of the invention is to be as set forth in the following claims.

I claim:

1. A collapsible funnel comprising:
side walls joined by longitudinal folds, a receiving opening and a dispensing opening;
retainer means to maintain the funnel in an expanded configuration, said retainer means comprising at least one flap member disposed at said receiving opening and bridging one of said longitudinal folds;
wherein said at least one flap member is inverted from a non-engaged position external to said receiving opening to an engaged position internal to said receiving opening and abutting at least two of said side walls to maintain said funnel in the expanded configuration.

2. The funnel of claim 1, further comprising a top edge defining said receiving opening, wherein said at least one flap member in the non-engaged position extends outwardly from said top edge.

3. The funnel of claim 2, wherein said at last one flap member comprises a top edge fold.

4. The funnel of claim 3, wherein said at least one flap member comprises a flap longitudinal fold.

5. The funnel of claim 4, wherein the number of said at least one flap members equals the number of said longitudinal folds.

6. The funnel of claim 1, wherein said at last one flap member comprises a top edge fold.

7. The funnel of claim 6, wherein said at least one flap member comprises a flap longitudinal fold.

8. The funnel of claim 7, wherein the number of said at least one flap members equals the number of said longitudinal folds.

9. The funnel of claim 1, wherein said at least one flap member comprises a flap longitudinal fold.

10. The funnel of claim 9, wherein the number of said at least one flap members equals the number of said longitudinal folds.

11. The funnel of claim 1, wherein the number of said at least one flap members equals the number of said longitudinal folds.

12. The funnel of claim 1, wherein said retainer means further comprises at least one small flap member disposed at said dispensing opening and bridging one of said longitudinal folds;
wherein said at least one small flap member is inverted from a non-engaged position external to said dispensing opening to an engaged position internal to said dispensing opening and abutting at least two of said side walls to maintain said funnel in the expanded configuration.

13. A collapsible funnel comprising:
side walls joined by longitudinal folds, a top edge defining a receiving opening and a bottom edge defining a dispensing opening;
retainer means to maintain the funnel in an expanded configuration, said retainer means comprising at least one flap member bridging one of said longitudinal folds and extending outwardly from said top edge;
said at least one flap member comprising a flap longitudinal fold;
wherein said at least one flap member is inverted from a non-engaged position external to said receiving opening to an engaged position internal to said receiving opening and abutting at least two of said side walls to maintain said funnel in the expanded configuration, said flap longitudinal fold being aligned in parallel with said one of said longitudinal folds.

14. The funnel of claim 13, wherein said at last one flap member comprises a top edge fold, said top edge fold being an extension of said top edge.

15. The funnel of claim 13, wherein the number of said at least one flap members equals the number of said longitudinal folds.

16. The funnel of claim 13, wherein said retainer means further comprises at least one small flap member bridging one of said longitudinal folds and extending outwardly from said bottom edge;
wherein said at least one small flap member is inverted from a non-engaged position external to said dispensing opening to an engaged position internal to said dispensing opening and abutting at least two of said side walls to maintain said funnel in the expanded configuration.
